(19) United States
(12) Patent Application Publication
(10) Pub. No.: US 2026/0356158 A1
(43) Pub. Date: Nov. 12, 2026

(54) Heating System for a Motor Vehicle Roof, Motor Vehicle Roof for a Motor Vehicle, and Motor Vehicle Comprising a Motor Vehicle Roof

(71) Applicant: Bayerische Motoren Werke Aktiengesellschaft, Muenchen (DE)

(72) Inventor: Fabian HEHL, Muenchen (DE)

(21) Appl. No.: 19/129,343

(22) PCT Filed: Dec. 22, 2023
(86) PCT No.: PCT/EP2023/087545

§ 371 Date: May 13, 2025

(30) Foreign Application Priority Data
Jan. 25, 2023 (DE) 10 2023 101 747.0

(51) Int. Cl. B60H 1/00; B60H 1/22

(52) U.S. Cl. CPC B60H 1/00742; B60H 1/2218; B60H 1/2227; B60H 2001/224; B60H 2001/2246; B60H 2001/2265; B60H 2001/2293

(57) ABSTRACT

A heating system for a motor vehicle roof of a motor vehicle, and a motor vehicle roof which has the heating system, includes a heating element assembly which is designed to be installed into a roof liner of the motor vehicle roof. The heating system additionally has an image detection sensor system which is designed to capture an image of the head of a user of the motor vehicle. The heating system also has an image analysis unit, which is designed to ascertain the head coverage status of the user based on the image. A controller is configured so as to meter a heat output provided by a heat energy source to the heating element assembly on the basis of the detected head coverage status.

### BACKGROUND AND SUMMARY

The present invention relates to a heating system for a roof of a motor vehicle. The invention moreover relates to a motor vehicle roof of this type which comprises the heating system. The invention further relates to a motor vehicle which is equipped with a motor vehicle roof which comprises the heating system.

In electrically powered motor vehicles, the traction battery thereof is arranged in or on the underfloor of the motor vehicle. In order to enable the maintenance of an appropriate headroom for occupants in the interior of an electric vehicle of this type, such vehicles, in comparison with motor vehicles, the traction battery of which is installed elsewhere (and particularly in comparison with conventional motor vehicles which are powered by means of a combustion engine), assume a greater vehicle height. However, it is a known objective that a center of gravity of a vehicle—particularly in consideration of handling and associated safety issues—should be arranged as low as possible. There is consequently a requirement, firstly for the traction battery to be positioned as far down as possible in the motor vehicle, and secondly for the motor vehicle to be configured with the lowest possible vehicle height. To this end, there is an option for a motor vehicle roof to be configured with the smallest possible thickness, and/or for the roof to be designed such that—in relation to an average vehicle user—it is arranged particularly close to the head of the user. For example, a glass roof can be employed. In consequence, however, heat emitted from the head of the user is conducted in a particularly rapid manner, via the roof, into the environment of the motor vehicle, as a result of which the user, in such a case, experiences a particularly rapid and uncomfortable feeling of cold in the head. For users wearing a short haircut, users having sparse hair growth or having a bald spot, this effect is further exacerbated, particularly if they are not wearing a cap.

From the prior art, for example from DE 10 2020 127 121 A1 or DE 10 2019 208 691 A1 , motor vehicle roofs are known which comprise a heating device. DE 11 2021 000 312 T5 and DE 10 2020 003 881 A1 disclose a passenger heating system for a motor vehicle, by means of which different physical passenger zones can be heated in a mutually separate manner.

The object of the invention is the provision of a particularly efficient solution, by means of which heat can be delivered in a user-specific and appropriate manner to a user in an interior of a motor vehicle.

This object is fulfilled by the subject matter of the independent patent claims. Further potential configurations of the invention are disclosed in the sub-claims, in the description and in the figures. Features, advantages and potential configurations which are presented in the context of the description of one element of the subject matter of the independent claims, in an inclusive manner with respect to categories and embodiments, are to be considered as at least analogous to features, advantages and potential configurations of the respective subject matter of the other independent patent claims, and of any potential combination of the subject matter of the independent claims, optionally in association with one or more of the sub-claims.

According to the invention, a heating system for a motor vehicle roof is proposed. A motor vehicle roof is further proposed which comprises the heating system. A motor vehicle is moreover proposed which comprises the motor vehicle roof and which is configured, for example, as a passenger car. Additionally, a method for operating the heating system readily proceeds from the description. In a regulation installation position, the heating system forms a constituent element of the motor vehicle roof. Moreover, in a regulation installation position, the motor vehicle roof forms a constituent element of the motor vehicle. The motor vehicle roof can be a solid roof, of the type which is employed, for example, in saloons, coupés, etc. The motor vehicle roof can moreover be a canopy or a segmented folding roof, of the type which is employed in cabriolets. In any event, the motor vehicle roof comprises organic and/or inorganic materials, for example timber, metallic materials, glass, textiles, etc.

The heating system comprises a heating element assembly, which is designed to be installed in a roof liner of the motor vehicle roof. Consequently, in the motor vehicle roof or the motor vehicle, the heating element assembly is thus installed or integrated in the roof liner. The heating element assembly comprises one or more heating elements wherein, by means of the respective heating element, in a heating operation of the heating system, ambient air in the environment of the respective heating element undergoes heat-up. The heating system, in particular the heating element assembly, can comprise air guide elements and/or air deflectors, in order to direct air thus heated in a particularly efficient and targeted manner (for example directly towards a user of the motor vehicle) in an interior of the motor vehicle.

The one or more heating elements constitute, for example, a respective heat-exchanger element, through the ducts of which, in a heating operation of the heating system, a fluid (a gas and/or a liquid) which undergoes heat-up by means of a heating unit is conducted, such that ambient air in the environment of the heat-exchanger element undergoes heat-up. In such a case, the respective heating element and the heating unit are fluidically interconnected or interconnectable by means of a pipe and/or hose system. Heat-up of the fluid can be executed by means of an exothermic reaction with oxygen associated with the ignition of combustible substances (for example a gas, a vapor, a liquid, a solid, or a mixture thereof).

The one or more heating elements further constitute, for example, a respective electrical heating element, through the heating lines or wires of which, in a heating operation of the heating system, electric current is conducted by means of a heating voltage source, such that heating lines/wires undergo heat-up, as a result of which ambient air in the environment of the electrical heating element undergoes heat-up. The respective electrical heating element can be configured as a heating mat. The heating voltage source and the respective heating element are electrically interconnected or interconnectable by means of an electrical conductor system which comprises, for example, power conductors and/or conductor rails. The heating voltage source can comprise a traction battery of the motor vehicle and/or another battery. Between the heating voltage source and the heating element assembly, a DC voltage converter can be connected, by means of which a heating voltage which is supplied by the heating voltage source can be smoothed and/or adapted to the requisite voltage level for the heating element assembly, for example 12 V (volts). The respective heating element can be, for example, a photovoltaic element.

The heating system further comprises an image capture sensor system, which is designed to capture an image of a head of a user of the motor vehicle. The image capture sensor system comprises an image sensor (for example a camera) or multiple image sensors. The respective image sensor for the motor vehicle roof or the motor vehicle can be arranged in the interior, or on a bodyshell of the motor vehicle. In the operation of the heating system, by means of the image sensor or image sensors, the image of the head of the user is captured. This capture can be executed as the user enters the motor vehicle-for example by means of a first image sensor of the image capture sensor system—and/or once the user has taken their seat in the interior of the motor vehicle—for example by means of a second image sensor of the image capture sensor system.

A further feature of the heating system is an image evaluation unit, which is designed to ascertain a head covering status of the user on the basis of the image. A head covering is to be understood herein as both a natural human head covering formed by hair, and as an artificial head covering. This means that, by means of the image evaluation unit, it is ascertained whether the user of the motor vehicle or of the heating system is wearing a short haircut, has a sparse/light growth of hair, or has a bald spot. Alternatively or additionally, it is ascertained whether the user is wearing an artificial head covering, for example a cap, a hat, a bonnet, etc. To this end, it is provided that the image evaluation unit supplies the image of the head in the form of an image file wherein, for example, by means of an image data processing function, it is ascertained whether and/or, if so, how many regions of the scalp are present on the image which are not covered by a natural (or artificial) head covering. It can also be ascertained whether and/or, if so, how many regions of the scalp are present on the image which are distinguished from bare scalp, as they are covered by hair and/or by an artificial head covering. The image evaluation unit can be a computer unit on which a software is saved which, upon the execution thereof by the computer unit, initiates the ascertainment of the head covering status of the user by reference to the image of the head. The computer unit can be a control device of the heating system, a control device of the motor vehicle roof, or a control device, in particular a central control device, of the motor vehicle. Accordingly, the image evaluation unit can be a software module, which is executed by means of the corresponding control device, in particular by means of the central control device, for the ascertainment of head covering status.

A control system of the heating system, for example the control device of the heating system, is designed, according to the head covering status, to meter a heating power which is delivered by means of a heating energy source to the heating element assembly, i.e. to the heating element or heating elements. The control system can be a second computer unit on which a control software is saved which, upon the execution thereof, initiates the appropriate direction or delivery of heating energy from the heating energy source of the heating element assembly, as required. The second computer unit can be a control device of the heating system, a control device of the motor vehicle roof or a control device, in particular a central control device, of the motor vehicle. Accordingly, the control system can constitute a second software module which, by means of the corresponding control device, in particular by means of the central control device, is executed for the control of the heating system. The heating energy source, which can be an element of the heating system, an element of the motor vehicle roof and/or an element of the motor vehicle, according to the presence of the heating element/heating elements by way of a heat-exchanger element or electrical heating element, comprises the heating unit and/or the heating voltage source. In the event that, by means of the image evaluation unit, it is/has been established that the user has only little or no hair on their head, or has a bald spot and/or is not wearing any artificial head covering, the heating system is operated by means of the control system such that the heating element assembly delivers a first heating power of the heating energy source. Conversely, in the event that it is/has been established by means of the image evaluation unit that the user has plentiful hair on their head, or has a dense hair growth and/or is wearing a head covering, the heating system is operated by means of the control system such that the heating element assembly delivers a second heating power of the heating energy source. The first heating power is greater than the second heating power. Expressed in simple terms, by means of the heating system, on the basis of the hair growth of the user, a greater or lesser heating power is delivered to the heating element or heating elements, such that the head of the user is correspondingly heated to a greater or lesser degree.

In this manner, the individual circumstances of the user are considered in the provision of heating power, and heating power is not delivered indiscriminately by means of the heating system. More heat is appropriately delivered to a user who has little hair on their head, whereas less heat is appropriately delivered to a user having plentiful hair on their head. Heat is thus delivered to a user in the interior of the motor vehicle in a user-specific and appropriate arrangement, as a result of which the heating system is operated in a particularly energy-efficient manner. Moreover, a manual activation/deactivation and/or adjustment of heat which is delivered to the user is also contemplated, wherein the heating system then comprises a corresponding hardware and/or software control element which is operable by the user. The control element can comprise an output unit, for example a display, such as a heads-up display or similar, in order to indicate current setting parameters of the heating system to the user.

In a further potential embodiment, one or more of the heating elements of the heating element assembly is/are formed by a (respective) photovoltaic element, which is configured to operate in a voltage generating operating mode, in which an electric voltage is supplied by means of the heating element, and in a heating operating mode, in which heat is delivered by means of the heating element. The control system is configured to selectively operate the heating element in the voltage generating operating mode or in the heating operating mode. Accordingly, the respective heating element which is embodied as a photovoltaic element can execute a switchover between the voltage generating operating mode and the heating operating mode, in particular by means of the control system. The heating element thus advantageously assumes a dual functionality, namely—in the first instance—it functions in the voltage generating operating mode as an energy conversion element, by means of which sunlight is converted into an electric voltage for employment on board the motor vehicle and—in the second instance—it functions in the heating operating mode as a heating element, by means of which heat is delivered to the user in the interior of the motor vehicle. In the heating operating mode, the photovoltaic element functions as an infrared light-emitting diode, and thus as an infrared heat source. In particular, the photovoltaic element is configured, in a targeted manner, for regulation operation in both the heating operating mode and in the voltage generating operating mode.

According to a potential further development, the heating element is configured as a flexible photovoltaic foil. This provides advantages with respect to a particular diversity of options for the employment of the heating or photovoltaic element. For example, the photovoltaic foil can be applied to curved sections of the motor vehicle roof. Moreover, the photovoltaic foil is particularly thin, as a result of which the construction of a particularly thin motor vehicle roof is enabled, notwithstanding the incorporation of the heating element therein. The photovoltaic foil can be produced in all possible colors, from black through to white.

According to a further potential embodiment, the photovoltaic foil is transparent and, in particular, is transparent with perfect fidelity, as a result of which the heating element can advantageously be employed in conjunction with a glass roofing element of the motor vehicle roof. According to a further development, the photovoltaic foil can be 100% translucent or transparent, i.e. crystal clear. In a potential further development of the motor vehicle roof, the latter comprises a glass roofing element of this type, having an inner glass pane and an outer glass pane, wherein the transparent heating element or the transparent photovoltaic foil is arranged between the glass panes. Accordingly, a transparency of the glass roofing element is not impaired by the heating element. This is desirable, as transparent glass roofs or glass roofing elements provide a particularly advantageous sense of space for the user, particularly in the event that the motor vehicle roof is arranged particularly close to the head of the user.

According to a further potential configuration, the heating system comprises two or more heating element groups, having one or more heating elements of the heating element assembly. A first of the heating element groups, i.e. for example a first heating element, is assigned to a first seating area of the motor vehicle, whereas a second of the heating element groups, i.e. for example a second heating element, is assigned to a second seating area of the motor vehicle. The heating element groups, by means of the control system, are controllable in a separate or mutually independent manner. The control system is thus configured, according to the head covering status of the user, to execute the separate metering of heating power which is delivered to the heating element groups. The respective seating area can be, for example, an individual seat or a row of seats of the motor vehicle. In particular, the heating system comprises as many heating element groups as the motor vehicle comprises seating areas. If, in the operation of the heating system, it is thus ascertained that a first user who has little hair on their head and/or who is not wearing an artificial head covering has entered the first seating area or is sitting in the first seating area, the heating system is controlled by means of the control system such that the first and higher heating power of the heating energy source is delivered to the first user, by means of the first heating element or the first heating elements of the first heating element group. If, moreover, in the operation of the heating system, it is ascertained that a second user who has plentiful hair on their head and/or who is wearing a head covering has entered the second seating area or is sitting in the second seating area, the heating system is simultaneously controlled by means of the control system such that the second and lower heating power of the heating energy source is delivered to the second user, by means of the second heating element or the second heating elements of the second heating element group. It can be provided that the heating system, for each seating area and/or for each user, comprises a respectively assigned image capture sensor system, and/or that the image capture sensor system is designed, for each user, to capture an individual image of the user. Ascertainment of the head covering status of two or more users by means of one image, which shows the heads of two or more users, is also contemplated. On the grounds of the separately controllable heating element groups, the heating system can be operated in a more energy-efficient manner, and any unnecessary heating/heat-up of the entire motor vehicle roof can advantageously be omitted. Instead, an individually tailored heating power or heat is delivered to users. Accordingly, electrical energy stored in the vehicle is not wasted by an unnecessary heating of the entire motor vehicle roof and can be employed, for example, in the interests of the electrically powered driving range of the motor vehicle.

According to a potential further development, the heating system comprises a seating area occupancy sensor system, which is designed to capture an occupancy of the seating areas, wherein the control system is configured, according to the occupancy of the corresponding seating area and according to a head covering status, to execute the separate metering of heating power on the heating elements. The seating area occupancy sensor system comprises one seating area occupancy sensor or multiple seating area occupancy sensors. In particular, the respective seating area occupancy sensor is constituted by a sensor which, independently of the heating system, is employed in any event in the motor vehicle roof and/or in the motor vehicle. By way of a respective seating area occupancy sensor, the seating area occupancy sensor system can comprise, for example, a door contact sensor, a backrest locking sensor, a seatbelt buckle sensor, a thermal sensor, a seat occupancy sensor mat, a contact sensor, an image sensor (in particular a camera), a radar sensor, a laser sensor, a LiDAR sensor, an ultrasound sensor, a motion detection sensor, a microphone and/or a control element (in particular, a steering wheel and/or pedals, etc.). In particular, the respective seating area occupancy sensor is connected or connectable to the control system, for the purposes of sensor data transmission. It is further contemplated that the seating area occupancy sensor is connected or connectable to another control unit of the motor vehicle roof or of the motor vehicle, in particular to the central control device wherein, in the operation of the heating system, sensor data from the sensor which functions as a seating area occupancy sensor, by means of the other control unit, can then be delivered to the control system or to a passenger detection unit. The passenger detection unit can be a third computer unit, on which a third software is saved which, upon the execution thereof, initiates the ascertainment by the third computer unit of seating area occupancy, by reference to data from the seating area occupancy sensor system. The third computer unit can be a control device of the heating system, a control device of the motor vehicle roof or a control device, in particular a central control device, of the motor vehicle. Accordingly, the passenger detection unit can constitute a third software module, which is executed by means of the corresponding control device, in particular by means of the central control device, for the purposes of seating area occupancy detection. By means of the seating area occupancy sensor system it can be ascertained, in a particularly accurate and reliable manner, whether a user is sitting in the motor vehicle and, if so, in which of the seating areas they are sitting. By the employment of a sensor fusion of two or more of the above-mentioned seating area occupancy sensors, the accuracy and reliability of seat occupancy capture are further improved. If, in the operation of the heating system, it is thus detected that a user of the motor vehicle is seated in the first seating area, the motor vehicle roof is heated at this location wherein, for example, heating power is delivered to the first heating element group which is assigned to the first seating area, by means of the control system. At the same time, in the second seating area, the interior is not heated by means of the heating system in the event that, in the operation of the heating system, it is detected that no user is seated in the second seating area; thus, by means of the control system, no heating power is delivered by means of the control system to the second heating element group which is assigned to the second seating area. Accordingly, particular consideration is assigned to a heating system which is operable in a particularly energy-efficient manner.

According to a further potential embodiment of the heating system, it is provided that the heating system comprises a temperature sensor system which, in turn, comprises one or more of the following temperature sensors:
an exterior temperature sensor for capturing an exterior temperature, i.e. a present temperature in an environment of the motor vehicle;
an interior temperature sensor for capturing an interior temperature;
a roof liner temperature sensor for capturing a roof liner temperature.

According to this embodiment, the control system is moreover configured, on the basis of the exterior temperature and/or the interior temperature and/or the roof liner temperature, and according to a head covering status, to execute a metering of heating power on the heating element assembly, i.e. on the heating element or heating elements. To this end, in particular, a respective limiting temperature, i.e. an exterior limiting temperature, an interior limiting temperature and/or a roof liner limiting temperature is stipulated. In the operation of the heating system, a heating power is delivered to the heating element assembly or to the heating element or elements which is/are arranged in the motor vehicle roof, by means of the control system, in the event that the exterior temperature sensor, the interior temperature sensor and/or the roof liner temperature sensor captures a temperature which is lower than the corresponding limiting temperature. The exterior limiting temperature, the interior limiting temperature and the roof liner limiting temperature can assume different values. According to a further development, it is provided that, for capturing the exterior temperature, alternatively or additionally, data are supplied by means of an off-board backend server facility. In this context, accordingly, the control system and the backend server facility are connected or connectable for the purposes of data transmission, in particular by means of a telematic control unit of the motor vehicle. The backend server facility receives meteorological data, in particular from a meteorological service. Thus, in the operation of the heating system, in an advantageous manner, not only the head covering status of the user or users is considered, but also temperature conditions which are in force in the vehicle and/or in the environment of the vehicle.

Further features of the invention can be inferred from the claims, the figures and the description of the figures. Features and combinations of features specified in the preceding description, and features or combinations of features illustrated hereinafter in the description of the figures, and/or in the figures alone, are not only applicable in the respectively indicated combination, but also in other combinations, or in isolation, without departing from the scope of the invention.

### BRIEF DESCRIPTION OF THE DRAWING

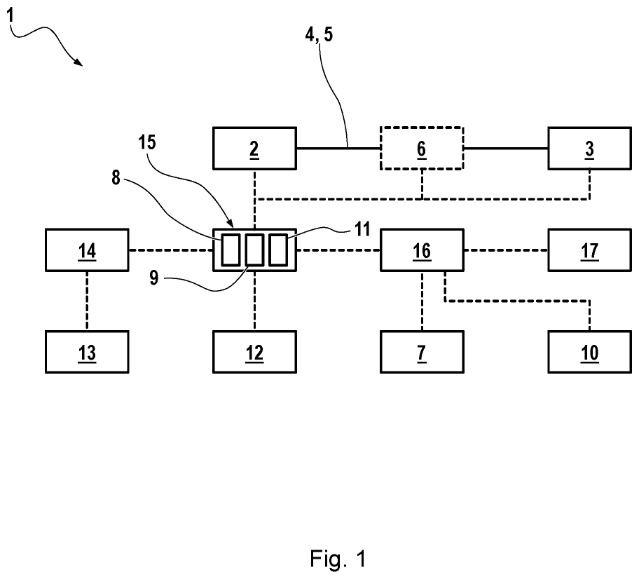

The single FIG. 1 is a schematic block circuit diagram of a heating system for a motor vehicle roof.

### DETAILED DESCRIPTION OF THE DRAWING

In FIG. 1, identical and functionally equivalent elements are identified by the same reference numbers. Although the motor vehicle roof, and the motor vehicle which incorporates the motor vehicle roof, are not represented in FIG. 1, the heating system 1, the motor vehicle and the motor vehicle roof are represented hereinafter in a common description. Insofar as the motor vehicle roof incorporates the heating system 1 as a component thereof, the motor vehicle which comprises the motor vehicle roof incorporates the heating system 1 as a component thereof.

The heating system 1 or the motor vehicle comprises a heating energy source 2, which is configured as a heating voltage source or as a heating unit. The heating system 1 further comprises a heating element assembly 3, the heating elements of which are installed in a roof liner of the motor vehicle roof. In the event that the heating elements are respectively configured as heat-exchanger elements, in this case, the heating energy source 2 which comprises the heating unit and the heating element assembly 3 are directly and mutually fluidically connected or connectable by means of a pipe and/or hose system 4. Through ducts in the respective heat-exchanger element, in a heating operation of the heating system 1, a fluid which is heated by means of the heating unit of the heating energy source 2 is conducted, such that air in the environment of the heat-exchanger element undergoes heat-up. In the event that the heating elements are respectively configured as electrical heating elements, in this case, the heating energy source 2 which comprises the heating voltage source and the heating element assembly 3 are mutually electrically connected or connectable by means of an electrical conductor system 5, in the present case via a DC voltage converter 6. Through heating lines or heating wires of the respective electrical heating element, in a heating operation of the heating system, an electric current is conducted by means of a heating voltage source of the heating energy source 2, such that the heating lines/wires undergo heat-up and, as a result, air in the environment of the electrical heating element undergoes heat-up. In the present case, at least one of the heating elements of the heating element assembly 3 is configured as a photovoltaic element. It can be provided that the heating system 1 both comprises at least one heating element which is configured as a heat-exchanger element, and at least one heating element which is configured as an electrical heating element, wherein the heating energy source 2 thus comprises both the heating unit and the heating voltage source, which are connected/connectable to the associated heating elements, for the transmission of heat energy, by means of the pipe/hose system 4 or by means of the electrical conductor system 5.

The heating system 1 moreover comprises an image capture sensor system 7 by means of which, in the operation of the heating system 1, an image of a head of the user of the motor vehicle is captured. Image capture can be executed as the user enters the motor vehicle and/or if the user is seated in the interior of the motor vehicle. The image is delivered to an image evaluation unit 8 of the heating system 1, by means of which, on the basis of the image, a head covering status of the user is ascertained, for example as to whether the user is wearing a short haircut, has only a sparse (remaining) hair growth or a bald spot, has a thick/dense hair growth and/or is wearing an artificial head covering (a cap, hat, etc.). An outcome of this head covering status ascertainment is then delivered to a control system 9 of the heating system 1 by means of which, in the operation of the heating system 1, according to the head covering status thus captured or according to the outcome of the head covering status ascertainment, a metering is executed of heating power which is delivered to the heating element assembly 3, i.e. to the heating element or heating elements, by means of the heating energy source 2. The control system 9 thus controls the heating energy source 2 (i.e. the heating voltage source and/or the heating unit) such that a greater or lesser quantity of heating power (heated fluid and/or a heating voltage) is appropriately delivered to the heating element or heating elements. In other words, a first and higher heating power is delivered to the user in the event that, for example, the user has only little hair remaining, whereas a second and lower heating power is delivered to the user in the event that, for example, the user is wearing an artificial head covering.

In the present case, at least one of the heating elements of the heating element assembly 3 is configured as a photovoltaic element in the form of a transparent photovoltaic foil or matting. The heating element which is embodied in the form of a photovoltaic element is thus designed, in a regulation manner, to be selectively operated in a voltage generating operating mode and in a heating operating mode. In the voltage generating operating mode, an electric voltage is delivered by means of the heating element/photovoltaic element, as a result of which, for example, a battery, in particular a traction battery of the motor vehicle is electrically charged. Conversely, in the heating operating mode, an electric current is converted into heat by means of the heating element/photovoltaic element. Electric current for the generation of heat is supplied to the heating element/photovoltaic element by means of the battery, in particular the traction battery of the motor vehicle. The control system 9 is configured to selectively operate the heating element/photovoltaic element in the voltage generating operating mode or in the heating operating mode, or to execute a switchover between the above-mentioned operating modes.

In the present case, the motor vehicle roof comprises a glass roofing element, for example a glass pane lifting roof, a fixed or partially retractable panoramic glass roofing section, etc. The glass roofing element comprises an inner glass pane, which is arranged on an interior side, and an outer glass pane, which is arranged on an exterior side, which glass panes are mutually connected. The transparent photovoltaic foil, or the correspondingly configured heating element, is arranged between the glass panes.

In the present example, the heating system 1 moreover comprises a first heating element group of the heating element assembly 3, which is assigned to a first seating area of the motor vehicle, and a second heating element group of the heating element assembly 3, which is assigned to a second seating area of the motor vehicle. The respective heating element group comprises one heating element or multiple heating elements of the heating element assembly 3. In the present case, the control system 9 is moreover designed, according to the head covering status captured, to execute the separate metering of heating power delivered to the heating element groups. For the operation of the heating system 1, it thus applies that the heating element groups, or the heating elements which are combined to form the heating element groups, are controlled by means of the control system 9 in a separate or mutually independent manner, wherein:
if it ascertained that a first user who has little hair on their head and/or who is not wearing any artificial head covering enters the first seating area, or is seated in the first seating area, the first and higher heating power of the heating energy source 2 is delivered thereto; and
if it is ascertained that a second user who has plentiful hair on their hand and/or who is wearing an artificial head covering enters the second seating area, or is seated in the second seating area, the second and lower heating power of the heating energy source 2 is delivered thereto.

In the operation of the heating system 1, a seating area occupancy sensor system 10 of the heating system 1 captures an occupancy of the seating areas. By means of the control system 9, according to the occupancy of the corresponding seating area and according to the head covering status of the user thus captured, a separate metering of heating power on the heating elements is executed. If, in the operation of the heating system 1, it is thus detected that a user of the motor vehicle is seated in the first seating area, the motor vehicle roof is heated at this location wherein, by means of the control system 9, heating power is delivered to the first heating element group, which is assigned to the first seating area. At the same time, in the second heating area, the interior is not heated by means of the heating system 1 in the event that, in the operation of the heating system 1, it is detected that no user is seated in the second seating area. In the present example, it is provided that the seating area occupancy sensor system 10 delivers its sensor data to a passenger detection unit 11 which then ascertains, by way of an outcome, whether a user/passenger is seated in the respective seating area or otherwise. By means of the passenger detection unit 11, the resulting outcome is then delivered to the control system 9.

In the present case, the heating system 1 moreover comprises a temperature sensor system 12 which, in the present example, comprises an exterior temperature sensor, an interior temperature sensor and a roof liner temperature sensor. By means of the exterior temperature sensor, in the operation of the heating system 1, an exterior temperature is detected, i.e. a temperature which is in force in the environment of the motor vehicle. By means of the interior temperature sensor, in the operation of the heating system 1, an interior temperature is detected and, by means of the roof liner temperature sensor, in the operation of the heating system 1, a roof liner temperature is detected. According to this embodiment, the control system 9 is moreover configured, on the basis of the exterior temperature and/or the interior temperature and/or the roof liner temperature, and according to a head covering status, to execute a metering of heating power on the heating element assembly 3, i.e. on the heating element or heating elements. To this end, an exterior limiting temperature, for example 10° C. (degrees Celsius), an interior limiting temperature (for example 10° C.) and/or a roof liner limiting temperature (for example 5° C.) is stipulated. In the operation of the heating system 1, a heating power is delivered to the heating element assembly 3 by means of the control system 9, in the event that the exterior temperature sensor, the interior temperature sensor and/or the roof liner temperature sensor of the temperature sensor system 12 captures a temperature which is lower than the corresponding limiting temperature. Alternatively or additionally, for the detection of the exterior temperature, meteorological data are retrieved from a backend server facility 13. The backend server facility 13 receives meteorological data, in particular temperature data, in the present case from a meteorological service, and delivers these temperature data to the control system 9. In the present case, it is provided that the backend server facility 13 delivers meteorological data or temperature data to a telematic control unit 14 of the motor vehicle.

In the present case, the image evaluation unit 8, the control system 9 and the passenger detection unit 11 are respective software modules, which are executed by means of a central control device 15 which, in particular, is a constituent element of the motor vehicle, for or in the operation of the heating system 1. The central control device is a computer unit.

In FIG. 1, solid lines represent how elements or components of the heating system 1, in particular of the motor vehicle roof or of the motor vehicle, are mutually connected or connectable for the transmission of heating power. In FIG. 1, broken lines represent how elements or components of the heating system 1, in particular of the motor vehicle roof or of the motor vehicle, are or can be mutually coupled for the wireless and/or hard-wire transmission of data and/or control signals. From FIG. 1, it can thus be seen that the image capture sensor system 7 and the central control device 15, or the control system 9 thereof, is/can be indirectly mutually coupled, namely via a further control device 16 which, in the present case, is a dedicated sensor system control device for the image capture sensor system 7 and/or the seating area occupancy sensor system 10. By means of the central control device 15—for example, by means of an on-board data bus, in particular a CAN-bus, the heating energy source 2, the heating element assembly 3, optionally the DC voltage converter 6, the image capture sensor system 7 and the seating area occupancy sensor system 10 (in each case via the control device 16), the temperature sensor system 12, a control element 17 (in this case via the control device 16) and the telematic control unit 14 are connected for the purposes of data transmission. The backend server facility 13 and the telematic control unit 14, in particular by means of a wireless data connection (for example a cellular network connection, such as LTE, 5G, WLAN, etc.) are interconnected for the purposes of data transmission. Cameras and displays of the heating system 1, alternatively or additionally, can be connected by means of a standardized SerDes (serializer/deserializer) connection. In the present example, the control element 17 comprises means for the manual activation/deactivation and/or adjustment of heat or heating power, and means for the display of current setting parameters of the heating system 1. The control element 17 is, for example, a central control display of the motor vehicle, a vehicle infotainment system, a heads-up display, etc.

A heating system control function which is embodied by means of the control device 9 executes a decision, on the basis of information which is supplied thereto, as to whether a heating operation of the heating system 1 is required or otherwise. The heating system control function receives an input from the passenger detection unit 11 as to the location, i.e. the seating area, in which a passenger is situated in the motor vehicle. By means of the heating system 1, it is moreover ascertained whether a bald passenger is present in the motor vehicle. For example, the motor vehicle roof can be heated in its entirety or in a zonal arrangement only, wherein only those heating element groups which are assigned to seating areas in which a passenger is situated are supplied with heating power, extending to the heating of corresponding regions above passengers thus detected. The decision as to which of the heating element groups in the interior are intended to supply heat requires information from a multiplicity of sensors. These include sensors for the measurement of the interior temperature, the exterior temperature and the temperature of the motor vehicle roof (in particular a glass roof). These sensors can be connected directly to the central control device 15, or to a further control device 16 which is situated in the vehicle, and which relays the requisite information or data to the central control device 15. It is also contemplated for heating power to be controlled on the basis of meteorological forecasts or meteorological data from the backend. To this end, relevant switch-on or switch-off commands, or setting commands, are transmitted from the backend server facility 13 via the telematic control unit 14 to the control system 9 in the central control device 15. In the event that preliminarily defined limiting temperatures are undershot (for example in the interior), the heating system 1 is switched to a heating operation. Potentially, a temperature value only, for example the interior temperature, can be employed as a basis for this purpose, or dependencies, for example between the interior temperature, the exterior temperature and/or the roof liner temperature can be established. The switch-on or switch-off, and/or the setting of operating parameters for the heating system 1, is executed by means of a control signal, which is transmitted to the corresponding components by means of a control system 9 which is arranged in the central control device 15. Alternatively or additionally, further mutually independent switch-on and switch-off thresholds can be provided, in particular for seasons of the year, the height of passengers, gender, whether the passenger is wearing an artificial head covering, whether the passenger has a bald spot, etc. If it is possible for a passenger to be unambiguously identified, for example by means of facial recognition and image matching using cameras of the heating system 1 and/or of the motor vehicle, it is also possible for a customized setting option to be provided. In this case, the user can execute a setting for their preferred level of warmth in specific situations, or for whether any infeed of heat from the heating system 1 is required whatsoever. In particular, a step-wise setting of heating power is contemplated, for example “minimum”, “medium” or “maximum”.

The image evaluation unit 8—which is also described as a baldness detection system—can be a standalone software module or an integrated component of the passenger detection unit 11. The baldness detection system detects baldness in the user or users, and delivers this information, in combination with seating area occupancy, to the control system 9. For human-machine communication between the motor vehicle and the user, particularly for setting and/or activating/deactivating the heating system 1, the control element 17 is provided in the present case. Moreover, an acoustic output of current operating parameters of the heating system can be executed, wherein the control element will then comprise a loudspeaker.

An exemplary potential application of the heating system 1 can be represented as follows: it is wintertime, the exterior temperature is −20° C., and the customer has parked the motor vehicle in front of their house. The interior temperature of the vehicle is 0° C., and the roof liner temperature is −10° C. The customer (with no hair, and no artificial head covering) moves towards the motor vehicle, climbs inside, and thus prepares to start a journey. By the approach to the vehicle, by an unlocking of the vehicle and/or by an entry into the vehicle, the central control device 15 is activated. The passenger detection unit 11 detects, by means of sensor data fusion, that the user has occupied the driver's seat. The image evaluation unit 8 evaluates the image of the head of the user which has been captured by means of the image capture sensor system 7, and detects that the user has no hair. Given that, in the present case, the exterior temperature, the interior temperature and the roof liner temperature assume a lower value than the stipulated limiting temperatures, the corresponding heating power is delivered to the heating element assembly 3 by means of the control system 9, in order to supply heat to the user via the heating system 1.

A further relevant application for the heating system 1 is a preconditioning of the motor vehicle roof by reference to a user setting. For example, the user can define a departure time, when they require the motor vehicle to be heated. This preconditioning includes the heating of the motor vehicle roof, where this is required by the customer. This proactive switch-on information for the heating system 1 can be set, for example, in the motor vehicle. It is further contemplated that the user, by means of a remote control function, in particular by means of a personal computer unit, such as a smartphone, etc., delivers relevant information for this purpose to the control system 9. In particular, the above-mentioned information for operating or controlling the heating system 1 can be transmitted to the backend server facility 13, and communicated from thence to the motor vehicle or to the heating system 1.

### LIST OF REFERENCE NUMBERS

1 Heating system
2 Heating energy source
3 Heating element assembly
4 Pipe or hose system
5 Electrical conductor system
6 DC voltage converter
7 Image capture sensor system
8 Image evaluation unit
9 Control system
10 Seating area occupancy sensor system
11 Passenger detection unit
12 Temperature sensor system
13 Backend server facility
14 Telematic control unit
15 Central control device
16 Further control device
17 Control element

1.-10. (canceled)

11. A heating system for a motor vehicle roof of a motor vehicle, comprising:
a heating element assembly configured to be installed in a roof liner of the motor vehicle roof;
an image capture sensor system configured to capture an image of a head of a user of the motor vehicle;
an image evaluation unit configured to ascertain a head covering status of the user based on the image; and
a control system configured to meter a heating power which is delivered via a heating energy source to the heating element assembly based on the head covering status.

12. The heating system according to claim 11, further comprising:
a heating element of the heating element assembly comprising a photovoltaic element, which is configured to operate in a voltage generating operating mode in which an electric voltage is supplied via the heating element, and in a heating operating mode in which heat is delivered via the heating element,
wherein the control system is configured to selectively operate the heating element in the voltage generating operating mode or in the heating operating mode.

13. The heating system according to claim 12, wherein the heating element is configured as a flexible photovoltaic foil.

14. The heating system according to claim 13, wherein the photovoltaic foil is transparent.

15. The heating system according to claim 11, wherein
a first heating element group of the heating element assembly is assigned to a first seating area of the motor vehicle, and
a second heating element group of the heating element assembly is assigned to a second seating area of the motor vehicle,
wherein the control system is configured, according to the head covering status ascertained, to execute separate metering of heating power delivered to the first and second heating element groups.

16. The heating system according to claim 15, further comprising:
a seating area occupancy sensor system configured to capture an occupancy of the first and second seating areas,
wherein the control system is configured, according to the occupancy of a corresponding seating area and according to a head covering status, to execute the separate metering of the heating power to the first and second heating element groups.

17. The heating system according to claim 11, further comprising a temperature sensor system comprising one or more of the following temperature sensors:
an exterior temperature sensor for capturing an exterior temperature;
an interior temperature sensor for capturing an interior temperature; or
a roof liner temperature sensor for capturing a roof liner temperature,
wherein the control system is configured, based on the exterior temperature and/or the interior temperature and/or the roof liner temperature, and according to a head covering status, to execute a metering of heating power to the heating element assembly.

18. A motor vehicle roof for a motor vehicle comprising a heating system according to claim 11.

19. The motor vehicle roof according to claim 18, further comprising:
a glass roof comprising an inner glass pane and an outer glass pane,
wherein the heating element, which is configured as a transparent photovoltaic foil, is arranged between the inner and outer glass panes.

20. A motor vehicle comprising a motor vehicle roof according to claim 19.

21. A motor vehicle comprising a motor vehicle roof according to claim 18.
